(19) United States
(12) Patent Application Publication
(10) Pub. No.: US 2007/0108357 A1
(43) Pub. Date: May 17, 2007

(54) Support bracket for bicycles

(76) Inventor: Daniel L. Plowman, St. Johns, MI (US)

Correspondence Address: PAPARELLA & ASSOCIATES, PLC, 930 N. WASHINGTON AVE., LANSING, MI, 48906, US

(21) Appl. No.: 11/281,025

(22) Filed: Nov. 17, 2005

(51) Int. Cl. F16B 45/00

(52) U.S. Cl. 248/304

(57) ABSTRACT

A mount for supporting a bicycle includes a first support adapted to be suspended from a generally flat surface, a second support including angularity disposed exterior arms, integrally connected to the first support, and a continuous flange disposed along the exterior lateral edges of the first and second supports.

### BACKGROUND OF THE INVENTION

The present invention relates to a support bracket generally, and more specifically to a mountable support bracket for bicycles and the like.

In recent years, the popularity of bicycling for sport, recreation, and transportation has increased. As such, bicycle carriers and holders of various sizes, shapes, and configurations have heretofore been developed. These holders typically provide a relatively easy and convenient approach for storing a bicycle between uses.

With the increased popularity of bicycling as a sport and recreational activity, bicycling equipment has drastically increased in performance, and accordingly, in price. With bicycles now routinely costing thousands of dollars, today's bicyclists do not simply store there bicycles on a garage floor where it can be knocked over and damaged. As such, storing bicycles using wall mounted carriers or ceiling hooks is advantageous in that it allows bicycles to be safely stored in an out-of-the-way location, conserves floor space, and decreases congestion in crowded or cluttered areas.

In general, these wall-mounted carriers have carrying arms that extend outwardly from the wall to suspend the bicycle therefrom. However, these carriers have heretofore taken the form of large brackets that are complicated, fabricated from numerous parts, and therefore, expensive to manufacture. In addition, because these carriers are typically fabricated from numerous parts, the strength of the carrier is decreased, and as such, may provide inadequate support. Moreover, many bicycling enthusiasts find it desirable to prominently display their bicycles. As such, these enthusiasts require, but have heretofore been unable to purchase, a carrier which is aesthetically pleasing.

Accordingly, a need exists for an improved bicycle-supporting bracket which has, among other advantages, increased strength, while simultaneously being aesthetically pleasing. Therefore, a bicycle-supporting bracket that solves the aforementioned disadvantages and having the aforementioned advantages is desired.

### SUMMARY OF THE PRESENT INVENTION

The aforementioned drawbacks and disadvantages of these bicycle supporting brackets have been identified and a solution is set forth herein by the inventive bicycle supporting bracket which includes, a mount for supporting a bicycle thereon comprising, a first support including a first end, wherein the first support is adapted to be suspended from a generally flat surface. The first support also includes a first strengthening member disposed thereon. A second support, having a second and a third end, is also included. The second support includes a pair of angularity disposed exterior lateral edges, wherein the exterior lateral edges converge at the second end, and diverge therefrom to the third end. The third end includes at least one upturned projection, and the second support further includes a second strengthening member disposed thereon. Further, the first end of the first support is angularity disposed on the second end of the second support, and the first and second strengthening members are joined to one another forming a single continuous strengthening flange.

Another aspect of the present invention includes a unitary mount for supporting a wheeled vehicle thereon comprising, a one-piece mount including a first support and a second support. The first support is adapted to suspend the mount from a generally flat surface, and the first support includes a first end. The second support comprises two angularity disposed arms, wherein the arms converge at a second end of the second support, and diverge therefrom to a third end of the second support. Each arm has an upturned projection disposed on the third end of the second support, and the arms define an opening therebetween. Further, the first end of the first support is integrally disposed on the second end of the second support at an angle. The one-piece mount also includes a first and a second exterior lateral edge. A continuous flange is disposed along each first and second exterior lateral edge of the mount and extends from at least a portion of the first support to at least a portion of the second support.

In another aspect of the present invention, a unitary mount for supporting a bicycle thereon comprises a one-piece mount including a first support and a second support. The first support is adapted to suspend the mount from a generally vertical wall surface and the first support includes a first end. The second support comprises two angularly disposed arms, the arms converging at a second end of the second support and diverging therefrom to a third end of the second support. Each arm has an upturned projection disposed on the third end of the second support and the arms define an opening therebetween. Further, the first end of the first support is integrally disposed on the second end of the second support at an angle of between about 75 degrees to about 85 degrees. The one-piece mount also includes a first and a second exterior lateral edge. A continuous flange is disposed along each first and second lateral edge of the mount and extends from at least a portion of the first support to at least a portion of the second support. Additionally, at least one aperture is disposed along at least one of the continuous flanges.

And still in another aspect of the present invention, a unitary mount for supporting a bicycle thereon comprises a one-piece mount including a first support and a second support. The first support is adapted to suspend the mount from a generally horizontal ceiling surface, and the first support includes a first end. The second support comprises two angularly disposed arms, the arms converging at a second end of the second support and diverging therefrom to a third end of the second support. Each arm having an upturned projection disposed on the third end of the second support, whereby the arms define an opening therebetween. The first end of the first support is integrally disposed on the second end of the second support at an angle of between about 90 degrees to about 180 degrees. The one-piece mount also includes a first and a second exterior lateral edge and a continuous flange is disposed along each first and second lateral edge of the mount and extends from at least a portion of the first member to at least a portion of the second member. Additionally, at least one aperture is disposed along at least one of the continuous flanges.

Other objects, advantages, and features of the invention will become apparent upon consideration of the following detailed description, when taken in conjunction with the accompanying drawings. The above brief description sets forth rather broadly the more important features of the present disclosure so that the detailed description that follows may be better understood, and so that the present contributions to the art may be better appreciated. There are, of course, additional features of the disclosures that will be described hereinafter which will form the subject matter of the claims.

In this respect, before explaining the preferred embodiment of the disclosure in detail, it is to be understood that the disclosure is not limited in its application to the details of the construction and the arrangement set forth in the following description or illustrated in the drawings. The bicycle support bracket of the present disclosure is capable of other embodiments and of being practiced and carried out in various ways. Also, it is to be understood that the phraseology and terminology employed herein are for description and not limitation. Where specific dimensional and material specifications have been included or omitted from the specification or the claims, or both, it is to be understood that the same are not to be incorporated into the claims.

As such, those skilled in the art will appreciate that the conception, upon which this disclosure is based, may readily be used as a basis for designing other structures, methods, and systems for carrying out the several purposes of the present invention. It is important, therefore, that the claims are regarded as including such equivalent constructions as far as they do not depart from the spirit and scope of the present invention.

Further, the purpose of the Abstract is to enable the U.S. Patent and Trademark Office and the public generally, and especially the scientists, engineers, and practioners in the art who are not familiar with the patent or legal terms of phraseology, to learn quickly from a cursory inspection the nature and essences of the technical disclosure of the application.

Accordingly, the Abstract is intended to define neither the invention nor the application, which is only measured by the claims, nor is it intended to be limiting as to the scope of the invention in any way.

These and other objects, along with the various features, and structures that characterize the invention, are pointed out with particularity in the claims annexed to and forming a part of this disclosure. For a better understanding of the bicycle support bracket of the present disclosure, its advantageous and the specific objects attained by its uses, reference should be made to the accompanying drawings and descriptive matter in which there are illustrated and described the preferred embodiments of the invention.

While embodiments of the bicycle support bracket are herein illustrated and described, it is to be appreciated that various changes, rearrangements and modifications maybe made therein, without departing from the scope of the invention as defined by the claims.

### BRIEF DESCRIPTION OF THE DRAWINGS

FIG. 1 is a top perspective view of the bicycle support bracket of the present invention, in a support position;

FIG. 2 is a front view of the bicycle support bracket of FIG. 1;

FIG. 3 is a left side view of the bicycle support bracket of FIG. 1;

FIG. 4 is a rear view of the bicycle support bracket of FIG. 1;

FIG. 5 is a top perspective view of another embodiment of the bicycle support bracket of the present invention;

FIG. 6 is a left side view of another embodiment of the bicycle support bracket of the present invention, in a support position;

FIG. 7 is a front view of the bicycle support bracket of FIG. 6;

FIG. 8 is a left side view of yet another embodiment of the bicycle support bracket of the present invention, in a support position;

FIG. 9 is a front view of the bicycle support bracket of FIG. 8;

FIG. 10 is a top perspective view of still another embodiment of the bicycle support bracket of the present invention, in a support position;

FIG. 11 is a front view of yet still another embodiment of the bicycle support bracket of the present invention, in a support position;

FIG. 12 is a left side view of another embodiment of the bicycle support bracket of the present invention, in a support position; and

FIG. 13 is a front perspective view of one embodiment of the bicycle support bracket of the present invention, suspended from a wall surface and supporting a bicycle thereon.

### DETAILED DESCRIPTION OF THE PREFERRED EMBODIMENT

The best mode for caring out the invention is presented in terms of the preferred embodiment, wherein similar referenced characters designate corresponding features throughout the several figures of the drawings.

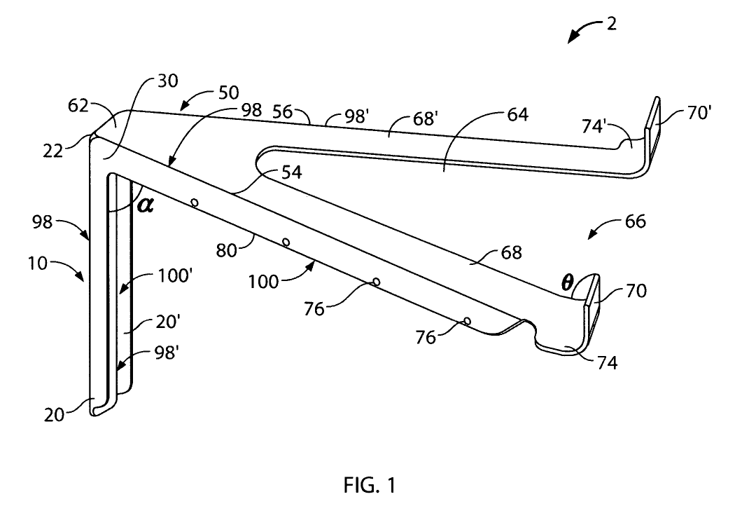

For purposes of description herein, the terms “upper”, “lower”, “right”, “left”, “rear”, “front”, “vertical”, “horizontal”, and derivatives thereof, shall relate to the invention as oriented in FIG. 1. However, it is to be understood that the invention may assume various alternative orientations, except where expressly specified to the contrary. It is also to be understood that the specific devices and processes illustrated in the attached drawings and described in the following specification are exemplary embodiments of the inventive concepts defined in the appended claims. Hence, specific dimensions and other physical characteristics relating to the embodiments disclosed herein are not to be considered as limiting, unless the claims expressly state otherwise.

Reference will now be made in detail to the present preferred embodiments of the invention, examples of which are illustrated in the accompanying drawings. Wherever possible, these same referenced numerals will be used throughout the drawings to refer to the same or like parts. The dimensions illustrated in the drawings (if provided) are included for purposes of example only and are not intended to limit the scope of the present invention.

Additionally, particular details in the drawings which are illustrated in hidden or dashed lines are to be considered as forming no part of the present invention.

The disadvantages and drawbacks of the prior art are overcome through the bicycle support bracket of the present invention, wherein one preferred embodiment is disclosed in FIGS. 1-4. Referring now to FIG. 1, there is shown in perspective view a bicycle support bracket, rack or mount 2 of the present invention. Support bracket 2 includes a first support 10 which is adapted to be suspended from a generally flat surface such as a wall surface. The first support includes a first end 22, and at least one strengthening member 20 disposed thereon. A second support 50 includes a pair of angularly disposed exterior lateral edges 54 and 56. Edges 54 and 56 converge at a second end 62 and diverge therefrom to a third end 66. The third end 66 of second support 50 also includes at least one upturned projection 70. Second support 50 further includes at least one second strengthening member 80 disposed thereon. In one preferred orientation, first support 10 and second support 50 are oriented such that first end 22 of support 10 is disposed on second end 62 of second support 50, whereby the first and second supports 10 and 50, respectively, are angularly disposed. Further, first and second strengthening members 20 and 80, respectively, are joined to one another as at, for example only, 30, forming a single continuous strengthening flange 100 disposed along exterior lateral mount edge 98.

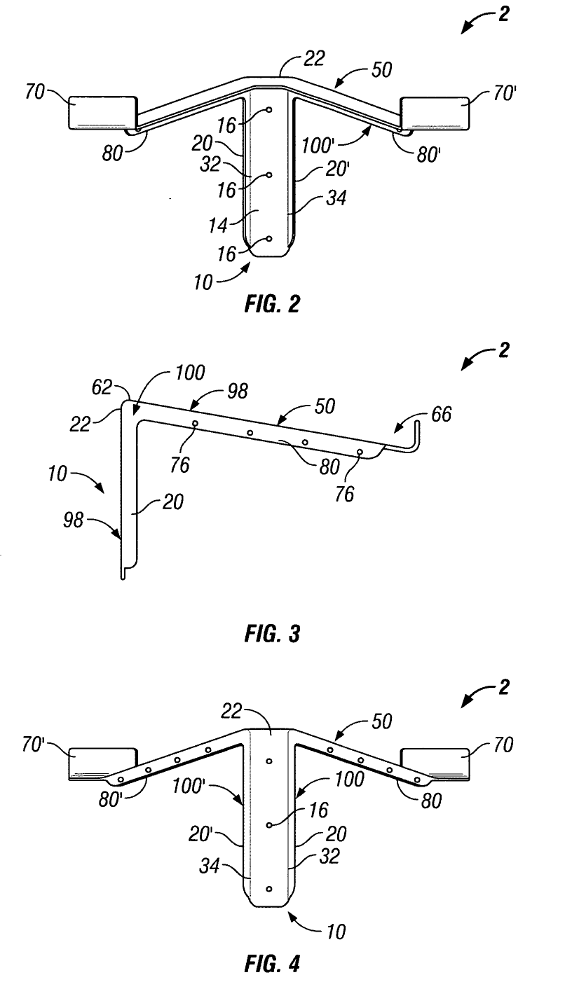

With respect to FIG. 2, a front view of the bicycle rack of FIG. 1 is illustrated. As shown, this embodiment is adapted to be suspended from a wall surface and is illustrated in a support position, ready to suspend a bicycle therefrom. In this embodiment, first support 10 is shown as having a generally rectangular shape, including a generally planar mounting surface 14 and generally parallel exterior lateral edges 32 and 34. Of course, other shapes and configurations may be used for first support 10. Mounting surface 14 is adapted for attachment to, and suspension from, a generally vertical surface, such as a wall. In the illustrated figure, surface 14 includes one or more apertures 16 for receiving a fastener (not shown) therethrough. In this manner, first support 10 can be suspended from the wall, wherein one or more fasteners (not shown) may be disposed through the one or more apertures 16 thereby rigidly securing first support 10 to the wall surface. Of course, this is in no way meant to be limiting, and first support 10 may be affixed or otherwise suspended from a wall surface by numerous other techniques as are well known in the art. At least one of the exterior lateral edges 32 and 34 includes a strengthening member 20. In one preferred embodiment, two such strengthening members are utilized and are illustrated in FIG. 2 as flanges 20 and 20′ disposed along exterior lateral edges 32, and 34, respectively. In this preferred embodiment, flanges 20 and 20′ are integrally fabricated from mounting surface 14 by bending or otherwise forming flanges 20 and 20′ from mounting surface 14 along exterior lateral edges 32 and 34, respectively.

The specific configurations and features of first support 10 may vary according to specific requirements. In the preferred embodiment, first support 10 is generally rectangular in shape and is fabricated in a one-piece configuration from ⅛^{th} inch steel, wherein flanges 20 and 20′ are formed from first support 10 by bending or otherwise. However, the shape of mounting surface 14 may vary according to specific requirements, and need not be rectangular in configuration. Further, although one preferred embodiment of first support 10 is fabricated from steel utilizing bending techniques, other ridged materials and fabrication techniques maybe used. For example, first support 10 may be molded from a plastic material. In addition, although this particular embodiment of first support 10 and flanges 20 and 20′ is fabricated into a one-piece configuration, multiple pieces can be utilized, and assembled by various means such as fasteners, welding, and other techniques well known in the art.

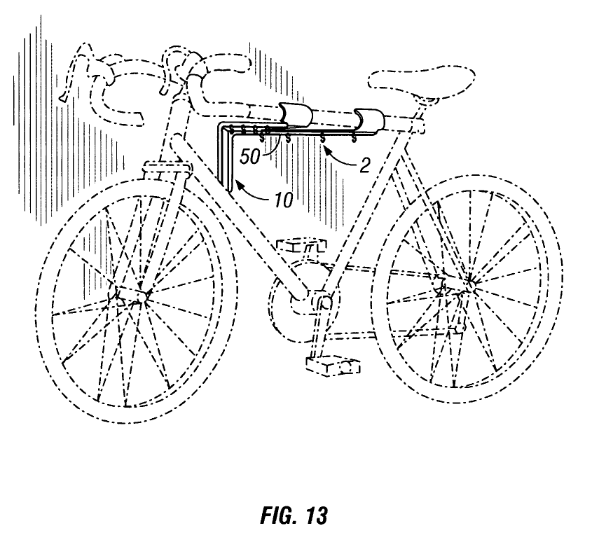

Returning focus to FIG. 1, second support 50 includes a pair of angularly disposed exterior lateral edges 54 and 56 which converge toward a second end 62 and diverge toward a third end 66, thereby defining an opening 64 therebetween, and forming angularly disposed arms 68 and 68′. In this embodiment, opening 64 is U-shaped and arms 68 and 68′ are utilized to support a bicycle thereon. In this embodiment, the bicycle is supported by its frame at the third end 66 of each arm 68 and 68′ (see FIG. 13).

With respect to one another, the angle of arms 68 and 68′ may vary according to specific requirements. In one preferred embodiment the angle ranges from about 25 degrees to about 55 degrees, more preferably from about 30 degrees to about 50 degrees, and most preferably from about 35 degrees to about 45 degrees. As illustrated in FIGS. 1-4, the angle is about 39 degrees. Disposed on arms 68 and 68′ at third end 66 are upturned projections 70 and 70′, respectively, which may be formed by upwardly bending end 66 of arms 68 and 68′. Upturned projections 70 and 70′ are typically angled at an angle theta (Θ) which ranges from about 45 degrees to about 170 degrees, more preferably from about 60 degrees to about 120 degrees, and most preferably from about 70 degrees to about 110 degrees. In the embodiment illustrated in FIGS. 1-4, theta is about 80 degrees. Projections 70 and 70′ are utilized to restrict the movement of a bicycle frame which may be supported on arms 68 and 68′, thereby keeping the bicycle frame from slipping off end 66 of arms 68 and 68′ when supported thereon. Also disposed at third end 66 of second support 50, on arms 68 and 68′, are stabilization or support pads 74 and 74′ which extend from arms 68 and 68′, respectively. Although support pads 74 and 74′ may extend inwardly, toward opening 64, in one preferred embodiment support pads 74 and 74′ extend outwardly, away from lateral edges 54 and 56. Support pads 74 and 74′ are utilized to increase the pad or surface area of arms 68 and 68′, at third end 66, in order to provide increased surface area for supporting a bicycle frame thereon.

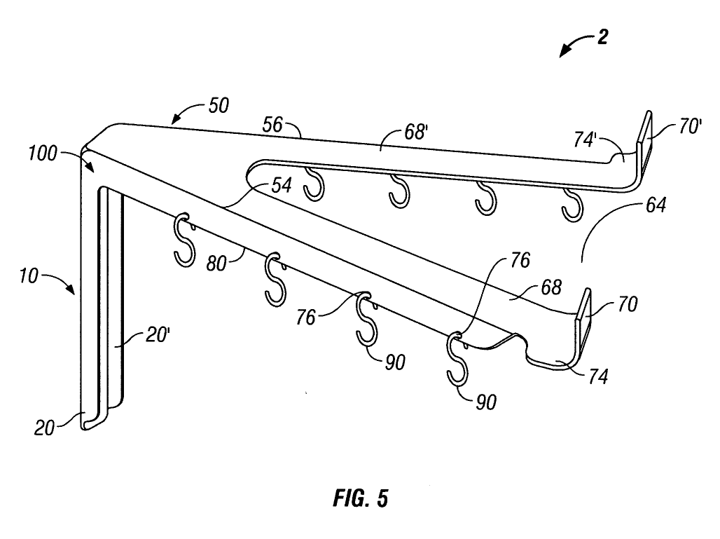

Additionally, disposed at least partially along at least one of the exterior lateral edges 54, and 56 is a second strengthening member 80. In a preferred embodiment, two such strengthening members are utilized, are illustrated in FIGS. 1-4 as flanges 80 and 80′, and are disposed along exterior lateral edges 54 and 56, respectively. In this embodiment, flanges 80 and 80′ are integrally fabricated from second support surface 50 by bending or otherwise forming flanges 80 and 80′ along exterior lateral edges 54 and 56, respectively. In addition to strengthening support 2, flanges 80 and 80′ may include one or more hanging features, devices or supports which are capable of hanging or suspending articles, for example bicycle equipment, therefrom. Such a feature is illustrated in FIGS. 1-4 as apertures 76. As best illustrated in FIG. 5, in one embodiment of an effective hanger is created by utilizing hooks through apertures 76. As illustrated, S-hooks 90 are used in this preferred embodiment to suspend or hang articles thereon.

The specific configuration and features of second support 50 may vary according to specific requirements. In the preferred embodiment, second support 50 is generally V-shaped and is fabricated into a one-piece configuration from ⅛^{th} inch steel, wherein flanges 80 and 80′ are integrally formed from second support 50 along exterior lateral edges 54 and 56. However, the shape of second support 50 may vary according to specific requirements and need not be V-shaped in configuration. Further, although one preferred embodiment of second support 50 is fabricated from steel by utilizing bending techniques, other ridged materials and fabrication techniques maybe used. For example, second support 50 may be molded from a plastic material. In addition, although one embodiment of second support 50 includes flanges 80 and 80′ and is fabricated into a one-piece configuration, multiple pieces may be utilized and assembled by various means such as fasteners, welding, as well as any other technique well known in the art.

Overall, mount 2 is fabricated from first support 10 and second support 50 by positioning first end 22 of first support 10 on second end 62 of second support 50 in an angularly disposed relationship. First support 10 is angled with respect to second support 50 at an angle alpha (α) which is between from about zero degrees to about 90 degrees, more preferably between from about 70 degrees to about 90 degrees, and most preferably from about 75 degrees to about 85 degrees. In one preferred embodiment, mount 2 is fabricated into a one-piece configuration, wherein first support 10 and second support 50 are integrally connected by welding or otherwise, and are affixed at an angle alpha of about 80 degrees. The fabrication of mount 2 into a one-piece configuration can be done by using one or more pieces of material. When more than one piece is used, for example only, a welding operation may be used. Of course, mount 2 can be fabricated utilizing a single piece of material or multiple pieces of material, and numerous fabricating and fastening techniques can be used. In the illustrated embodiments, mount 2 is fabricated by welding first end 22 of first support 10 to second end 62 of second support 50 yielding a one-piece configuration.

In order to maximize the strength of mount 2, flanges 20, 80 and 20′, 80′ are associated, connected to or otherwise formed into a pair of single continuous flanges 100 and 100′, respectively, and disposed along exterior lateral mount edges 98 and 98′, respectively. The resultant pair of continuous flanges 100 and 100′, act to transfer the stresses, associated with the suspension of the bicycle on second support 50, to first support 10, thereby increasing the strength of mount 2. In a preferred embodiment, flanges 20, 80 and 20′, 80′ are formed into continuous support members or flanges 100 and 100′, respectively, by welding.

While one preferred embodiment has been described, the specific characteristics of support bracket 2 may vary according to the specific requirements of the end user. Although the preferred embodiment utilizes a one piece construction, support bracket 2 may be fabricated from numerous parts. In addition, support bracket 2 may be fabricated by numerous other methods such as machining or molding, and may also be fabricated from numerous materials other then sheet metal, the prime characteristic being the material's ability to rigidly support a bicycle thereon.

By fabricating support bracket 2 from sheet steel utilizing stamping, folding and welding operations, a very economical bicycle rack has been developed which is simple in configuration and appearance, elegant, and yet very strong. In addition, support bracket 2 may be further enhanced by utilizing a powder coat finish to provide a durable yet protective finish, and yet further, a rubberized coating may be disposed on stabilization pads 74 and 74′, the ends of arms 68 and 68′ nearest end 66, and upturned projections 70 and 70′, to protect the bicycle frame from being scratched when disposed on second support 50 of support bracket 2.

FIG. 5 illustrates an embodiment wherein second strengthening flanges 80 and/or 80′ include one or more apertures 76 disposed therethrough for fastening or hanging miscellaneous articles thereon. In this embodiment, apertures 76 are adapted for receiving hooks therethrough. As illustrated, S-hooks 90 may be utilized, for example, to suspend articles thereon such as bicycle helmets, gloves or other objects for convenience. Of course, other style hooks may be utilized and further yet, features other than holes may be used to suspend the articles. For example, apertures of any geometry may be used. Additionally, other features such as projections, hooks, fingers and the like may be formed or attached anywhere along support flanges 100 and 100′ to support the various articles during storage.

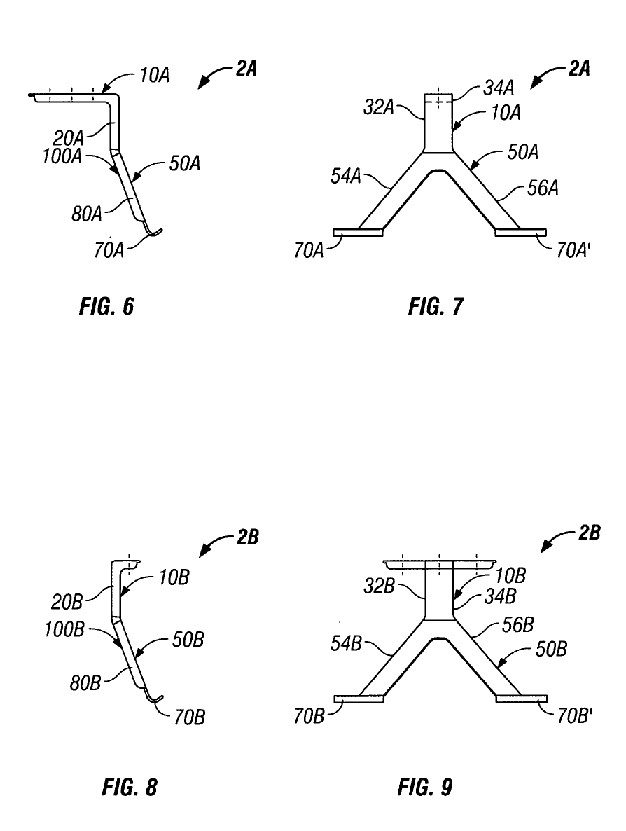

With respect to FIGS. 6 and 7, an alternative embodiment 2A is illustrated. Support bracket 2A is adapted to be suspended from a generally planar surface such as a ceiling. This embodiment is similar to mount 2 in construction and appearance. As such, the embodiments may have similar components which are described using numbers common to all embodiments. The differing embodiments, and the similar elements thereof, are distinguished by adding the letter A to the associated number. Mount 2A includes first support 10A which is L-shaped and preferably integrally connected to V-shaped second support 50A, whereby a bicycle may be supported via upturned projections 70A and 70A′. Mount 2A includes flanges 20A and 80A, preferable continuously disposed along lateral exterior edges 32A and 54A, respectively, forming a continuous flange 100A. Oppositely located are corresponding flanges 20A′ and 80A′ disposed along lateral exterior edges 34A and 56A, respectively, forming a continuous flange 10A′ (not shown). Upturned projections 70A and 70A′ are utilized to retain the bicycle thereon.

FIGS. 8 and 9 illustrate yet another embodiment capable of being suspended from a generally planar surface such as a ceiling. This embodiment is similar to mount 2A in construction and appearance. As such, the embodiments may have similar components which are described using numbers common to all embodiments. The differing embodiments, and the similar elements thereof, are distinguished by adding the letter B to the associated number. Mount 2B includes a T-shaped first support member 10B, V-shaped second support member 50B, first and second flanges 20B, 80B and 20B′, 80B′ (not shown) disposed along lateral exterior edges 32B, 54B, and 34B, 56B, respectively, forming continuous flanges 100B and 100B′ (not shown). Upturned projections 70B and 70B′ are again utilized to retain the bicycle thereon.

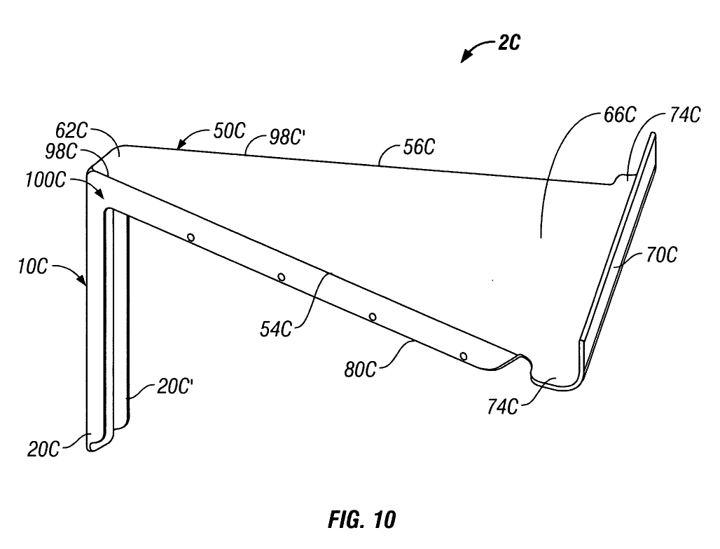

In yet another embodiment, mount 2C is illustrated in FIG. 10. This embodiment is similar to mount 2 in construction and appearance. As such, the embodiments may have similar components which are described using numbers common to all embodiments. The differing embodiments, and the similar elements thereof, are distinguished by adding the letter C to the associated number. First support 10C is is adapted to be suspended from a generally planar surface such as a wall. Second support 50C is V-shaped and includes angularly disposed exterior lateral edges 54C and 56C which converge towards second end 62C and diverge as they approach third end 66C. A pair of continuous flanges 100C and 100C′ are disposed along the lateral exterior edges 98C and 98C′ of mount 2C. Disposed along third end 66C is a single upturned edge 70C and a single stabilization pad 74C for supporting a bicycle thereon.

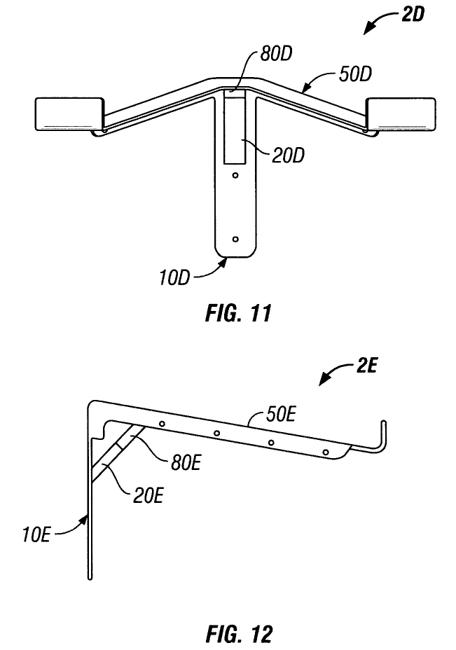

Yet another two embodiments 2D and 2E are illustrated in FIGS. 11 and 12 and include variations of first and second strengthening members 20 and 80. Namely, 20D, 80D and 20E, 80E, respectively. Strengthening members 20D, 80D and 20E, 80E, are illustrated as struts or angled brackets and are utilized to strengthen mount 2 either in place of, or in addition to, a continuous flange. As described previously, strengthening members 20D, 80D and 20E, 80E act to transfer the stresses on second support 50D and 50E, respectively, associated with supporting a bicycle, to first support 10D and 10E, respectively, thereby increasing the overall strength of mounts 2D and 2E. In the illustrated example, strengthening members 20D, 80D and 20E, 80E, are used in conjunction with a continuous strengthening flange.

FIG. 13 illustrates mount 2 in use. As illustrated, one or more fasteners, for example screws, are inserted through apertures 16 in first support 10, and into the associated wall structure, thereby securely supporting mount 2 to the wall structure. The bicycle is supported on mount 2 by positioning the bicycle frame on arms 68 and 68′ at end 66 of second support 50, on pads 74 and 74′. The bicycle is securely retained or captured thereon and kept from slipping off of arms 68 and 68′ by upturned projections 70 and/or 70′. Further, accessories such as helmets, gloves, or the like may be stored or hung next to the bicycle via apertures 76 and/or S hooks 90.

Advantageously, the bicycle support rack of the present invention is efficiently fabricated and elegantly designed while being engineered to support heavy loads. Consequently, the embodiments of the preferred invention disclosed herein reveal a bicycle supporting rack which has been reduced in cost, is more robust than existing designs, and can therefore carry or support higher loads than existing bicycle mounts. Additionally, the bicycle support rack of the present invention is more aesthetically appealing than prior art support brackets.

The solutions offered by the invention herein have thus been attained in an economical, practical, and facile manner. To whit, a novel bicycle support bracket which is cost effective, easily installed, strong, and aesthetically pleasing has been invented. While preferred embodiments and example configurations of the inventions have been herein illustrated, shown, and described, it is to be appreciated that various changes, rearrangements, and modifications may be made therein, without departing from the scope of the invention as defined by the claims. It is intended that the specific embodiments and configurements disclosed herein are illustrative of the preferred and best modes for practicing the invention, and should not be interpreted as limitations on the scope of the invention as defined by the claims, and it is to appreciated that various changes, rearrangements, and modifications may be made therein, without departing from the scope of the invention as defined by the claims.

The invention claimed is:

1. A mount for supporting a bicycle thereon comprising:
a first support including a first end, the first support adapted to be suspended from a generally flat surface, the first support including a first strengthening member disposed thereon;
a second support having a second and a third end, the second support including a pair of angularly disposed first exterior lateral edges, the exterior lateral edges converging at the second end and diverging therefrom to the third end, the third end including at least one upturned projection, the second support further including a second strengthening member disposed thereon;
wherein the first end of the first support is angularly disposed on the second end of the second support; and
the first and second strengthening members are joined to one another forming a single continuous strengthening flange.

2. The mount according to claim 1, wherein:
the first support is integral with the second support, thereby forming a one-piece mount.

3. The mount according to claim 1, wherein:
When the mount is disposed in a support position, the first support includes parallel exterior lateral edges.

4. The mount according to claim 1, wherein:
the first support is adapted to mount to a generally vertical wall surface.

5. The mount according to claim 1, wherein:
the first support is adapted to mount to a generally horizontal ceiling surface.

6. The mount according to claim 5, wherein:
the first support is L-shaped.

7. The mount according to claim 5, wherein:
the first support is T-shaped.

8. The mount according to claim 1, wherein:
the first strengthening member includes a first end;
the second strengthening member includes a second end; and
the first end of the first strengthening member is connected to the second end of the second strengthening member.

9. The mount according to claim 1, wherein:
the first strengthening member includes a pair of first strengthening flanges, each of the flanges disposed along at least a portion of one of a pair of second exterior lateral edges of the first support;
the second strengthening member includes a pair of second strengthening flanges, each of the flanges disposed along at least a portion of one of the pair of first exterior lateral edges of the second support; and
wherein each first strengthening flange disposed along one of the pair of second exterior lateral edges of the first support is continuous with each second strengthening flange disposed along the respective pair of first exterior lateral edges of the second support.

10. The mount according to claim 9, wherein:
at least one of each second strengthening flanges includes at least one hanging feature.

11. The mount according to claim 10, wherein:
the at least one hanging feature includes at least one aperture.

12. The mount according to claim 11, wherein:
the at least one aperture includes a hook suspended therefrom.

13. The mount according to claim 1, wherein:
the second support includes two angularly disposed arms, the arms converging at the second end of the second support and diverging therefrom to the third end of the second support, the arms separated by a generally U-shaped opening, and each of the arms having upturned projections disposed at the third end of the second support.

14. The mount according to claim 1, wherein:
the first and second supports are disposed with respect to each other at an angle of between about 75 degrees to about 85 degrees.

15. The mount according to claim 1, wherein:
the third end of the second support includes support pads extending from each of the first angularly disposed exterior lateral edges of the second support.

16. a unitary mount for supporting a wheeled vehicle thereon comprising:
A one-piece mount comprising a first support and a second support;
the first support adapted to suspend the mount from a generally flat surface, the first support including a first end;
the second support comprising two angularly disposed arms, the arms converging at a second end of the second support and diverging therefrom to a third end of the second support, each arm having an upturned projection disposed on the third end of the second support, the arms defining an opening therebetween;
wherein the first end of the first support is integrally disposed on the second end of the second support at an angle, the one-piece mount further including a first and a second exterior lateral edge; and
a continuous flange is disposed along each first and second exterior lateral edge of the mount and extends from at least a portion of the first support to at least a portion of the second support.

17. The mount according to claim 16, wherein:
at least a portion of at least one of the continuous flanges, the portion disposed along the second support, comprises at least one aperture.

18. The mount according to claim 17, wherein:
the at least one aperture includes a hook suspended therefrom.

19. The mount according to claim 16, wherein:
the angle the first and second supports are disposed at is between about 75 degrees to about 85 degrees, with respect to each other.

20. The mount according to claim 16, wherein:
the first support is adapted to mount to a generally horizontal ceiling surface.

21. The mount according to claim 20, wherein:
the first support is L-shaped.

22. The mount according to claim 20, wherein:
the first support is T-shaped.

23. The mount according to claim 16, wherein:
the arms include support pads disposed at the third end of the second support, the support pads extending from each first and second exterior lateral edge of the mount.

24. a unitary mount for supporting a bicycle thereon comprising:
A one-piece mount including a first support and a second support;
the first support adapted to suspend the mount from a generally vertical wall surface, the first support including a first end;
the second support comprising two angularly disposed arms, the arms converging at a second end of the second support and diverging therefrom to a third end of the second support, each arm having an upturned projection disposed on the third end of the second support, the arms defining an opening therebetween;
wherein the first end of the first support is integrally disposed on the second end of the second support at an angle of between about 75 degrees to about 85 degrees;
the one-piece mount further includes a first and a second exterior lateral edge;
a continuous flange is disposed along each first and second lateral edge of the mount and extends from at least a portion of the first support to at least a portion of the second support; and
at least one aperture is disposed along at least one of the continuous flanges.

25. The mount according to claim 24, wherein:
the at least one aperture includes a hook suspended therefrom.

26. The mount according to claim 25, wherein:
the at least one aperture includes an S-hook suspended therefrom.

27. The mount according to claim 24, wherein:
the third end of the second support includes support pads disposed at the third end, the support pads extending from each arm of the second support.

28. a unitary mount for supporting a bicycle thereon comprising:
A one-piece mount including a first support and a second support;
the first support adapted to suspend the mount from a generally horizontal ceiling surface, the first support including a first end;
the second support comprising two angularly disposed arms, the arms converging at a second end of the second support and diverging therefrom to a third end of the second support, each arm having an upturned projection disposed on the third end of the second support, the arms defining an opening therebetween;
wherein the first end of the first support is integrally disposed on the second end of the second support at an angle of between about 90 degrees to about 180 degrees;
the one-piece mount includes a first and a second exterior lateral edge;
a continuous flange is disposed along each first and second lateral edge of the mount and extends from at least a portion of the first member to at least a portion of the second member; and
at least one aperture is disposed along at least one of the continuous flanges.

29. The mount according to claim 28, wherein:
the first support is generally L-shaped and includes one leg adapted to be suspended from a ceiling.

30. The mount according to claim 28, wherein:
the first support is generally T-shaped and includes one leg adapted to be suspended from a ceiling.
